(19) United States
(12) Patent Application Publication
(10) Pub. No.: US 2016/0374897 A1
(43) Pub. Date: Dec. 29, 2016

(54) SIT DOWN SHOWER SPA AND METHOD OF FORMING SAME

(71) Applicant: My Spa, Inc., Ada, MI (US)

(72) Inventors: Bridget Carey, Ada, MI (US); Christina Norris, Holland, MI (US)

(73) Assignee: My Spa, Inc.

(21) Appl. No.: 15/249,086

(22) Filed: Aug. 26, 2016

Related U.S. Application Data
(60) Provisional application No. 62/221,463, filed on Sep. 21, 2015.

(51) Int. Cl. A61H 33/00; A47K 10/48; A47K 3/022

(52) U.S. Cl. CPC A61H 33/6063; A47K 3/022; A61H 33/005; A47K 10/48; A61H 2201/102; A61H 2201/10; A61H 2201/1604; A61H 2201/1633

(57) ABSTRACT

A sit down shower spa includes a spa housing having a step-in door and a reclinable seat positioned within an inner spa housing. A basin formed within a wall of the spa housing can be used for toiletries or can be used with an insert used for scented stones and or a waterfall accessory. A headrest is configured within a wall of the spa housing for providing a cushioned support for the user's head. In use, warm water is sprayed within the spa housing for cleaning the user's body such that the spa continually drains water providing the user with a spa that works as a sit down shower.

### FIELD OF THE INVENTION

The present invention relates generally to spray shower spas and more particularly to a personal spa having spray spouts for use in bathing including the elderly and disabled.

### BACKGROUND

Many people use a tub or spa for relaxation, massage, soaking and hydrotherapy. The hot water temperature is comforting and even therapeutic for some while others avoid it for that very reason. Although the terms tub, spa, Jacuzzi and whirlpool bath may seem interchangeable they refer to very distinct devices. Hot tubs hold and retain heated water and often have jets for massage purposes. Sometimes they are placed outdoors under a shelter and are constructed of wood or plastic. The tub heats water via an electric or natural gas heater. Sanitization is an important issue especially for hot tub owners because many bacteria and other organisms thrive in the high temperature wet environment so pumps, filters and chemicals are necessary to sanitize the water in to prevent damage to the hot tub. Similarly, a whirlpool bath is typically installed in a bathroom and are much less expensive than the outdoor tubs. A whirlpool bath is essentially a bathtub with jets attached. Although the tub fills with water, water sanitization is not a concern because the bath is drained after each use

Spas normally consist of a one-piece plastic tub made of fiberglass and acrylic and are commonly installed outdoors on a patio or deck. They too hold water but are installed indoors. Spas include a pressure system for jets that mix water and air to create whirlpool actions of horizontal water. Spas also require filtering systems and water treatment to reduce bacteria build-up since water remains in the spa at all times. An issue in using any spa with the elderly or disabled persons are the dangers associated with any body of water. Typically, the spa needs to be filled with water which can be problematic in both its use and in a health emergency.

Cleaning the elderly and disabled by a caregiver in a bath environment often creates many concerns since the user or occupant must be emerged in water to get clean. A shower often is not an option if the user cannot stand for any period of time. Moreover, a bathtub can make it difficult for both ingress and egress not to mention problems in the event of a medical emergency. Accordingly, a new apparatus is needed for use in cleaning these persons to avoid the pitfalls for presently available tubs, spas and shower equipment.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1A is top perspective view of the spa according to an embodiment of the invention.

FIG. 1B is a side view of the spa shown in FIG. 1A.

FIG. 2 is a top view of the spa shown in FIG. 1A.

FIG. 3 is a side cross section illustrating a user seated in the spa.

FIG. 4 is a side cross section illustrating the user seated in a reclined position within the spa.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a spray shower spa. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

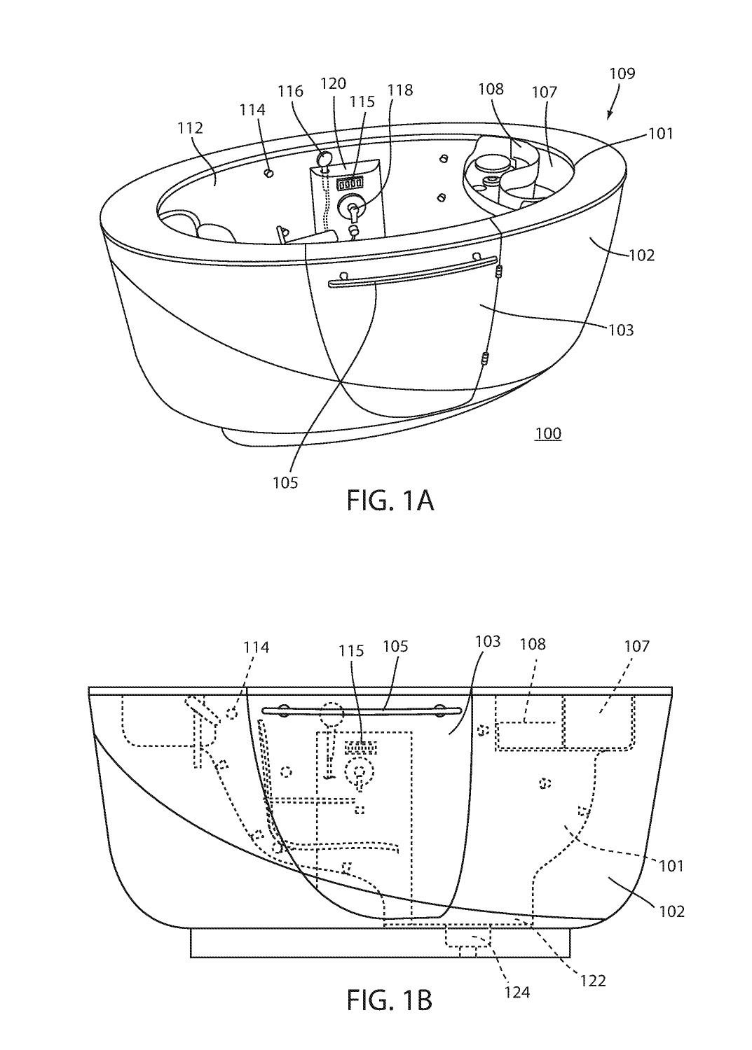

FIG. 1A is top perspective view of the spa according to an embodiment of the invention. FIG. 1B is a side view of the spa shown in FIG. 1A. With regard to both FIG. 1A and FIG. 1B, the spa 100 may be configured in a semicircular shape and is a sit down-in design especially useful for the elderly or disabled. As will be described herein, the spa 100 does not pool or fill with water but instead continually drains water during use. A plurality of water spouts are positioned around the user, to thoroughly clean and provide a seated type shower. Since the spa does not fill with water, the user can, at any time can easily and safely enter and exit the spa 100. Although the term “bath” may also be used herein with regard to the user, the spa 100 gives only a seated shower. The spa 100 gently sprays the user or occupant with water so that the occupant is never immersed in standing water within the spa. Instead, the user is cleaned by the water projected by water spouts positioned in the spa walls and under the seat. Water is continually drained during use of the spa so that water does not pool or stand inside the spa.

The spa 100 includes an inner housing 101 and outer housing 102. Although the outer housing 102 is also shown in a semi-circular or oval shape, those skilled in the art will recognize the outer housing 102 can be configured into a circle, square, rectangular or oval depending on the environment and application needed. It is typically manufactured of acrylic or fiberglass and may include various types of veneer wrap to provide a decorative appearance. The outer housing 102 can be wrapped in a bamboo veneer skin. Those skilled in the art will recognize that many types of decorative veneer materials are possible including but not limited to stainless steel, glass or colored plastics. Further, the spa 100 also includes a door 103 that includes a handle that also serves as a towel bar 105. The door 103 may be made of an acrylic or fiberglass material for providing a semi-transparent look. The door 103 has a substantially trapezoidal appearance with a sloping side end so that it is hinged to a portion of the inner housing 101 and outer housing 102. A spa basin 107 is positioned above foot end 109 of the spa 100. In one embodiment, the spa basin forms a cut-out and shelf for holding accessory items and toiletry supplies such as bottles and the like. In a second embodiment, a basin insert 108 may be positioned inside the spa basin 107 as an optional accessory. The spa insert 108 can be used for multiple purposes such as to hold spa stones, plants, aromatherapy scents and/or a waterfall that can enhance the spa experience for the user. The spa insert 108 has its own power source and can also include heating elements for heating or warming scents, soaps or other fluids or materials within the spa insert 108. Those skilled in the art will recognize the waterfall spilling from the spa basin 108 works to provide an enhanced visual and audible experience as falling water is typically pleasant to watch and listen.

On the spa wall 112, within the spa housing 101, are a plurality of water sprays or spouts 114 are positioned in a manner to achieve the best cleaning action to the user's body for their position. The spouts 114 are not water jets per se as they are not intended to mix air and water within the water stream. A water sprayer or wand 116 includes its own control valve 118 for controlling water pressure and temperature through the wand 116. The wand 116 is positioned within a sprayer housing 120 that protrudes from the spa wall 112. The sprayer housing 120 conceals a hose connected to the wand 116 so it is out of the user's way when not in use. The sprayer housing also includes a control valve 118 for controlling water pressure and temperature for the water spouts/water sprayers. As described herein, a control panel 115 is also for controlling other aspects of the spa and spa basin such as accessories used in connection with the spa basin. As seen in FIG. 1B, water moving through the floor of the spa 122 is easily removed using a drain 124 and/or pump so water does not collect or pool in the spa.

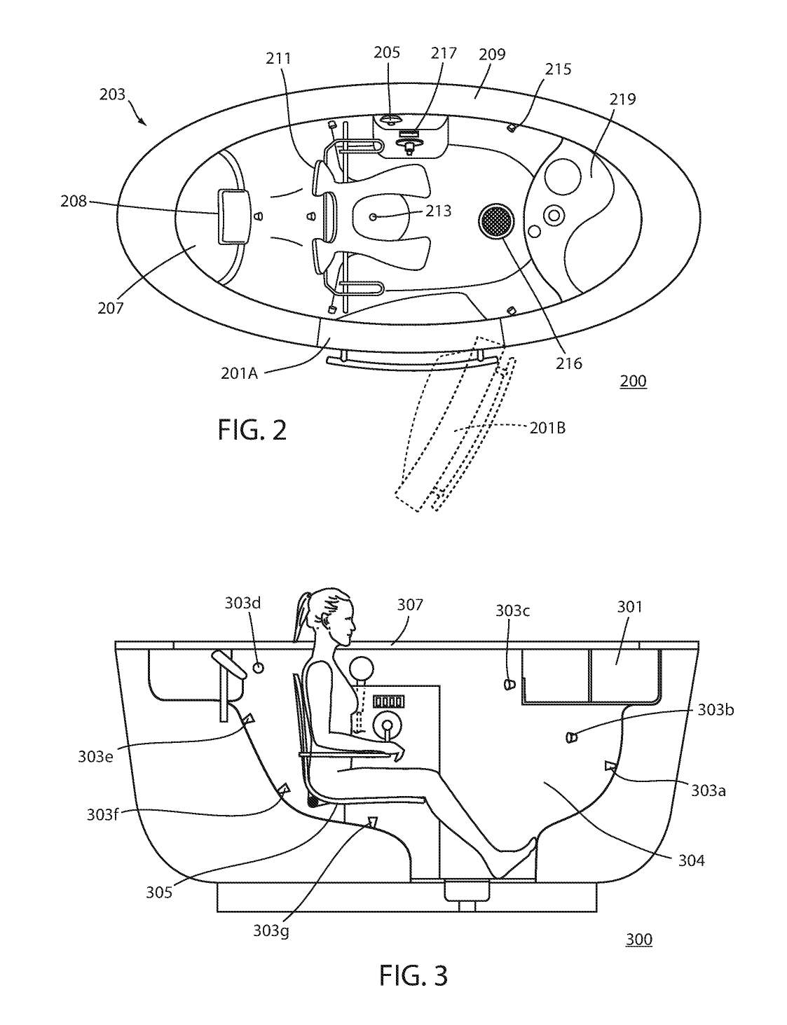

FIG. 2 is top view of the spa shown in FIG. 1A. As seen in FIG. 2, the spa 200 is illustrated with the door 201A shown in its closed poison while phantom lines illustrate the door 201B in an open position. The door 201A is hinged to one side allowing the user to easily sit into the spa. As noted with regard to FIGS. 1A and 1B, the spa 200 includes various options and features for enhancing the spa experience by providing scents, spa stones, plants and/or a waterfall. The spa may also include a sound system for playing MP3 music or the like as well as colored light(s) to provide both a decorative, soothing and relaxed atmosphere to the user. At the head end 203 of the spa 200 is an integrated hair wash basin 207 that works as an integrated sink and drain. The basin 207 works with spray wand 205 that can be used for washing the user's hair. As noted herein, the spray wand 205 may also include a retractable hose for ease of use.

The hair wash basin 207 includes a padded headrest 208 that extends in front of the hair wash basin 207 for user comfort when back of seat 211 is in a reclined position. A further feature of the spa is air ring 209. The air ring 209 is substantially oval shaped and positioned around the top edge of the spa inner housing. The air ring 209 is used to provide warm air that emanates from vents positioned under the ring. The air ring 209 works to both warm and dry the user when in the seat 211 after and during their seated shower. The air ring 209 includes a blower for blowing air though the air ring where the temperature of the blown air is adjustable by the user.

Further, the spa also includes an auto-cleaning cycle that can be automatically started using a timer or at some predetermined time after the user exits the spa. The auto-clean feature is controlled by panel 217 and can thoroughly clean and sanitize the spa for the next user. A cycle is initiated where cleaning solution can be dispensed using the water spouts. Hot water can then be dispensed by the spouts at some predetermined pressure to clean the spa. In another embodiment, the auto-clean system can use a pump for drawing a low viscosity cleaner/disinfectant, having an alcohol base, from a reservoir. The cleaner is then dispensed at the upper side of the spa housing and/or bottom side of the air ring. The cleaner/disinfectant will pass through a series of misting nozzles that can spray a fine mist of the cleaner/disinfectant across the interior of the spa. The alcohol base will evaporate in a short time and the spa can again be ready for another user. The air ring can then be initiated for some predetermined period where warm air is directed to the interior of the spa for evaporating lingering water after the cleaning cycle is completed.

During use, the user sits on an H-shaped seat 211, having an open back, for cleansing of the user's back and allowing the user to sit comfortably during their spa experience. The seat 211 is shaped in a manner so to allow spouts 215 positioned about the seat 211, to spray warm water on the user for cleaning. Those skilled in the art will further recognize that the H-shape of the seat 211 allows one or more spouts 213 to be placed under the user's lower torso and personal areas for gentle and thorough cleaning using water from the spout. Water is removed though drain 216. A control panel 217 includes an emergency call button integrated into housing 120 for calling a clinician or caregiver. The call button can actuate an audible alarm built into the spa and/or may make a 911 call, personal call or text to the caregiver.

Finally, a body wash and exfoliation dispenser is used in combination with the control panel for controlling the water spray as well as the dispensing of body wash from the plurality of spouts. The body wash dispenser uses the spouts 213 & 215 and can be controlled independently of the water temperature and pressure. A control panel 217 is configured to control all aspects of the spa. This might include but is not limited to the temperature and pressure of the water, light color and brightness of light used in the spa basin as well as the control and selection of music or other entertainment. Those skilled in the art will also recognize that a wireless controller can be configured to operate with the control panel 217 so that the sit down shower spa can be operated or automated using only a wireless device via Bluetooth™. In some cases, this may require independently operated wirelessly controlled valves and/or switching devices. For example, a cell phone can include a software app allowing the user to program and control the spa experience that includes but is not limited to water temperature and pressure and user entertainment such as lighting, music, scents and aromas and/or a waterfall all configured within the spa basin using the spa insert. A cleaning cycle can also be wirelessly controlled and/or scheduled by the user.

FIG. 3 is a cross sectional view illustrating a user seated within the spa 300. The user is shown facing forward towards toward the basin 301. A plurality of spouts 303a, 303b, 303c, 303d, 303e, 303f, 303g are optimally positioned inside the spa housing 304 and directed toward the user. The seat 305 is illustrated in a non-reclining position so the user sits erect. In use, the adjustable seat 305 is sized and oriented so that the user's head will extend slightly above the air ring 307. This allows for good visibility around the spa 300 while still enabling the spouts 303a, 303b, 303c, 303d, 303e, 303f, 303g inside the spa 300 to adequately clean all portions of the user's body except their face.

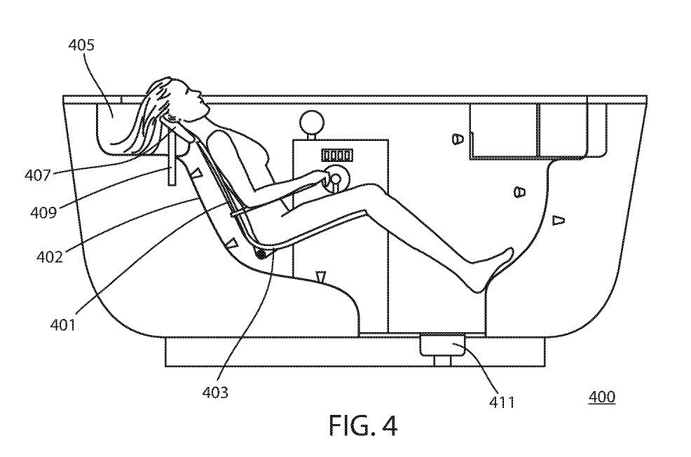

FIG. 4 is a side cross sectional view illustrating the user seated in a reclined position within the spa 400. The user is shown reclined in seat 403 so that the back of the seat is reclined by pivoting the back toward the rear 401 of the spa 400. The user's body is positioned such that the seat 403 does not touch or contact wall 402. This allows the user's head and neck to be positioned adjacent to the hair basin 405 on headrest 407. The head rest 407 includes a support member 409 for adjusting overall height. The user may rest their head on a cushioned area on the headrest that is typically used for washing their face and hair. Finally, a drain 411 is used for at the floor of the spa 400 so to continually drain and remove water for preventing any standing water buildup. The drain may optionally include a bilge pump to assist in rapid drainage of standing optional pump so that no water will pool or buildup inside the spa during use.

Those skilled in the art will further recognize that the spa as described herein will be useful in assisted living facilities, homes for the disabled, fitness club, private golf clubs, hotel resorts, cruise ships, yachts and private estates. There are many advantages in using various embodiment of the invention such the user does not have to wait for the spa to fill with water. The spa can be stopped at any time and the user can use the exit door. Spray spouts operate to gently wash and exfoliate (optional) the user's skin in a calm atmosphere. A gentle body wash enables the user to have a soothing experience. The seat is adjustable and ergonomic with an open middle for bottom washing. Moreover, the overall spa design is pleasing to the eye since its smooth lines avoid the look of square looking industrial spas. An optional hair wash basin gives the caregiver the option of washing the user's hair. A music and light experience can add to the overall therapeutic experience. Finally, an emergency call button at control panel 217 includes customizable settings for water temperature, pressure, body wash liquid, scents and aromas, music and lighting are also available through the use of an integrated control panel.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A sit down shower spa comprising:
an inner housing and outer housing such that the outer housing is decorative;
a reclinable seat positioned within the spa housing;
a plurality of spouts positioned about the inner housing for spraying water;
a basin formed within a wall of the spa housing for holding plants and/or spa stones;
a headrest attached to a wall of the spa housing for providing a cushioned support for the user's head; and
wherein water is sprayed from the plurality of spouts for cleaning the user's body such that the spa continually drains water without filling the spa.

2. A spa as in claim 1, wherein the plurality of spouts are positioned on all sides of the spa for cleaning the user.

3. A spa as in claim 1, wherein the plurality of spouts dispenses liquid body wash.

4. A spa as in claim 1, further comprising an air ring for directing warm air to dry the user.

5. A spa as in claim 1, further comprising a control panel for controlling water temperature and pressure, body wash, music, light therapy and scents, emanating from the basin.

6. A spa as in claim 5, wherein the control panel further includes an emergency call button for allowing the user to call for assistance.

7. A spa as in claim 1, further comprising a drain for continually removing water from the spa.

8. A sit down shower spa comprising:
an inner housing configured within an outer housing, the inner housing including;
a step-in door for allowing users walk-in access within the inner housing;
a reclinable seat configured integrally within the spa;
a plurality of spouts for projecting water and/or soap toward the reclinable seat;
a controller for providing wireless communication with a mobile device; and
a drain for continually removing water and the body wash from the interior of the spa during use.

9. A sit down shower spa as in claim 8, wherein the outer housing is a decorated as a façade.

10. A sit shower shower spa as in claim 8, further comprising:
a spa basin integrally formed within the inner housing; and
an insert configured to fit within the spa basin for holding at least one accessory item.

11. A sit down shower spa as in claim 8, wherein the at least one accessory item is a waterfall.

12. A sit down shower spa as in claim 8, further comprising:
an air ring configured around the interior perimeter of the spa for directing warm air for heating the user while the user is seated in the reclinable seat.

13. A sit down shower spa as in claim 8, further comprising:
a basin formed within a wall of the spa for holding at least one accessory item.

14. A sit down shower spa as in claim 13, wherein the at least one accessory item is an insertable waterfall.

15. A sit down shower spa as in claim 8, further comprising a control panel for controlling water temperature, water pressure, body wash quantity, music volume, light therapy type and scent type.

16. A sit down shower spa as in claim 8, wherein the control panel further includes an emergency call button for allowing the user to call for assistance.

17. A method for forming a sit down shower spa comprising the steps of:
forming an inner housing within an outer housing such that the outer housing is configurable as façade;
configuring a reclinable seat integrally within the spa;
configuring a plurality of spouts within a wall of the inner housing for projecting water toward the reclinable seat;
utilizing a controller in wireless communication with a mobile device for controlling operation of the spa;
configuring at least drain into the housing for continually removing water the interior of the spa during use; and
configuring an air ring around the interior perimeter of the inner housing for directing warm downwardly toward the reclinable seat.

18. A method of forming a sit down shower spa as in claim 17, further comprising the step of:
forming a basin within a wall of the spa housing for placement of toiletry items.

19. A method of forming a sit down shower spa as in claim 17, further comprising the step of:
inserting a waterfall within the basin.

20. A method of forming a sit down shower spa as in claim 17 further comprising the step of:
configuring a control panel within a wall of the inner housing for controlling at least one of water temperature, water pressure, body wash quantity, music volume, light type and scent type.
